(19) United States
(12) Patent Application Publication
(10) Pub. No.: US 2011/0280410 A1
(43) Pub. Date: Nov. 17, 2011

(54) ACTIVE NOISE CONTROL APPARATUS

(75) Inventors: Tsukasa Matono, Osaka (JP); Yoshio Nakamura, Osaka (JP)

(73) Assignee: Panasonic Corporation, Kadoma-shi (JP)

(21) Appl. No.: 13/145,360

(22) PCT Filed: Jan. 8, 2010
(86) PCT No.: PCT/JP2010/000074

§ 371 Date: Jul. 20, 2011

(30) Foreign Application Priority Data
Jan. 21, 2009 (JP) 2009-010555

(51) Int. Cl. G10K 11/16

(52) U.S. Cl. 381/71.1

(57) ABSTRACT

An active noise control apparatus includes a control frequency detector for determining a control frequency which is a frequency of a noise to be controlled, a sine-wave generator for generating a reference sine-wave signal having the determined control frequency, a cosine-wave generator for generating a reference cosine-wave signal having the determined control frequency, a first one-tap digital filter for outputting a first control signal obtained by multiplying the reference sine-wave signal by a first filter coefficient, a second one-tap digital filter for outputting a second control signal obtained by multiplying the reference cosine-wave signal by a second filter coefficient, an interference signal generator for generating an interference signal based on a noise control signal obtained by summing the first control signal and the second control signal, an error signal detector for detecting an error signal produced due to an interference between the interference signal and the noise, first and second coefficient updating units for updating the first and second filter coefficients according to the error signal, and a control frequency corrector for correcting the control frequency according to the first and second filter coefficients. This active noise control apparatus can reduce a noise effectively even if the control frequency shifts from the frequency of a noise actually generated.

### TECHNICAL FIELD

The present invention relates to an active noise control apparatus for actively reducing noise, such as vibration noise, having certain frequencies generated by rotating machines, such as a vehicle engine.

### BACKGROUND ART

A conventional active noise control apparatus described in Patent Literature 1 performs adaptive control by using an adaptive notch filter. This apparatus focuses on the fact that noise in a compartment of a vehicle is generated in synchronization with rotation of a power shaft of an engine, and uses the adaptive notch filter to reduce vibration noise inside the compartment of such frequencies caused by the rotation of the power shaft of the engine.

FIG. 9 is a block diagram of conventional active noise control apparatus 501 described in Patent Literature 1.

Engine rotation detector 1 outputs engine pulses P which are a pulse train having a frequency proportional to a rotating speed of the engine of the vehicle. Control frequency detector 2 calculates control frequency f[n] to be controlled based on the engine pulses P.

A signal output from control frequency detector 2 is input to sine-wave generator 5 and cosine-wave generator 6 that produce reference sine-wave signal x1[n] and reference cosine-wave signal x2[n] based on sine-wave table 3, respectively.

One-tap digital filter 7, an adaptive notch filter, stores filter coefficient W1[n], and outputs control signal y1[n] according to reference sine-wave signal x1[n] and filter coefficient W1[n].

Similarly, one-tap digital filter 8, an adaptive notch filter, stores filter coefficient W2[n], and outputs control signal y2[n] according to reference cosine-wave signal x2[n] and filter coefficient W2[n].

Noise control signal z[n] obtained by combining control signal y1[n] and control signal y2[n] is amplified by power amplifier 9, and output from loudspeaker 10 as noise canceling sound S101.

Microphone 11 detects a sound, as error signal E[n], produced by interference between noise canceling sound S101 and control target noise S102 generated due to vibration of the engine.

Coefficient updating unit 12 updates filter coefficient W1[n] of one-tap digital filter 7 from timely according to corrected sine-wave signal r1[n] generated by reference signal generator 14 based on characteristic table 4 so as to minimize an amplitude of error signal E[n].

Similarly, coefficient updating unit 13 updates filter coefficient W2[n] of one-tap digital filter 8 according to corrected cosine-wave signal r2[n].

Active noise control apparatus 501 reduces the noise by repeating the above process at predetermined intervals.

Control frequency f[n] determined by control frequency detector 2 may shift substantially from a frequency of the noise actually being generated if, for instance, a time lag, such as a delay, in engine pulses P output from engine rotation detector 1 due to malfunction of engine rotation detector 1. In this case, active noise control apparatus 501 cannot reduce the noise sufficiently only with the adaptive notch filter.

### Citation List

Patent Literature

Patent Literature 1: Japanese Patent Laid-Open Publication No. 2004-361721

### SUMMARY OF THE INVENTION

An active noise control apparatus includes a control frequency detector for determining a control frequency which is a frequency of a noise to be controlled, a sine-wave generator for generating a reference sine-wave signal having the determined control frequency, a cosine-wave generator for generating a reference cosine-wave signal having the determined control frequency, a first one-tap digital filter for outputting a first control signal obtained by multiplying the reference sine-wave signal by a first filter coefficient, a second one-tap digital filter for outputting a second control signal obtained by multiplying the reference cosine-wave signal by a second filter coefficient, an interference signal generator for generating an interference signal based on a noise control signal obtained by summing the first control signal and the second control signal, an error signal detector for detecting an error signal produced due to an interference between the interference signal and the noise, first and second coefficient updating units for updating the first and second filter coefficients according to the error signal, and a control frequency corrector for correcting the control frequency according to the first and second filter coefficients.

This active noise control apparatus can reduce a noise effectively even if the control frequency shifts from the frequency of a noise actually generated.

### BRIEF DESCRIPTION OF DRAWINGS

FIG. 1 is a block diagram of an active noise control apparatus according to an exemplary embodiment of the present invention.

FIG. 2A shows a sine-wave table of the active noise control apparatus according to the embodiment.

FIG. 2B illustrates a sine wave stored in the sine wave table shown in FIG. 2A.

FIG. 3A illustrates a phase characteristic of the active noise control apparatus according to the embodiment.

FIG. 3B illustrates a characteristic table corresponding to the phase characteristic illustrated in FIG. 3A.

FIG. 4 illustrates arguments of complex numbers in controlling a noise control signal of the active noise control apparatus according to the embodiment.

FIG. 5 illustrates arguments of the complex numbers shown in FIG. 4.

FIG. 6 illustrates arguments of other complex numbers in controlling the noise control signal of the active noise control apparatus according to the embodiment.

FIG. 7 illustrates arguments of the complex numbers shown in FIG. 6.

FIG. 8 is a block diagram of another active noise control apparatus according to the embodiment.

FIG. 9 is a block diagram of a conventional active noise control apparatus.

### DETAILED DESCRIPTION OF THE INVENTION

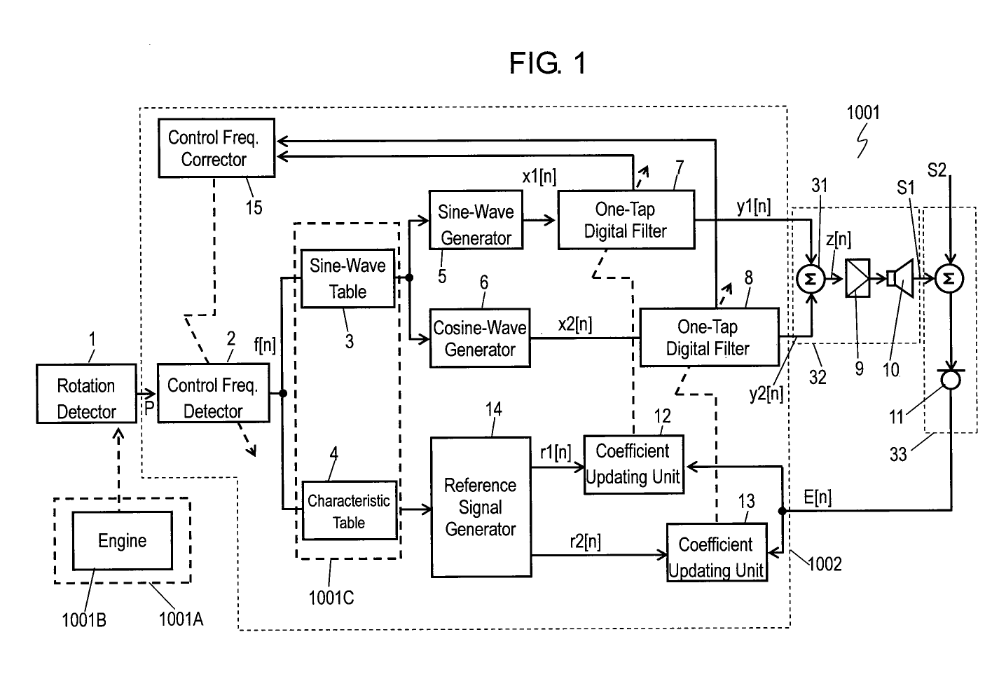

FIG. 1 is a block diagram of active noise control apparatus 1001 according to an exemplary embodiment of the present invention.

Engine rotation detector 1 detects a rotating speed of engine 1001B mounted to vehicle 1001A, a noise source, and outputs engine pulses P as a pulse train having a frequency proportional to the detected rotating speed of engine 1001B.

Control frequency detector 2 determines control frequency f[n] (Hz), which is a frequency of a noise to be controlled. Here, n is an integer. Control frequency detector 2 first estimate the frequency to be controlled as estimated control frequency fep[n] (Hz) roughly based on engine pulses P input from engine rotation detector 1. Control frequency detector 2 stores correction value fcomp[n] (Hz) for control frequency f[n], and calculates the control frequency f[n] (Hz) by correcting the estimated control frequency fep[n] (Hz) based on the correction value fcomp[n] (Hz).

Memory 1001C stores sine-wave table 3 that holds a plurality of sampled values obtained by discretizing one complete cycle of a sine wave. In other words, sine-wave table 3 holds the sampled values taken at N sampling points set by equally dividing the one cycle of the sine wave into N sections.

Sine-wave generator 5 generates reference sine-wave signal x1[n] by reading, from sine-wave table 3 at every sampling period, the sampled values at points of given intervals based on the control frequency f[n]. Simultaneously, cosine-wave generator 6 generates reference cosine-wave signal x2[n] by reading, from sine-wave table 3 at the every sampling period, the sampled values at points advancing the points of sine-wave generator 5 by just N/4 points of the given intervals based on the control frequency f[n]. The reference cosine-wave signal x2[n] obtained here has a phase advancing a phase of reference sine-wave signal x1[n] by 90 degrees. When the reading point exceeds the number N, sine-wave generator 5 and cosine-wave generator 6 reads one of the sampled values at a point obtained by subtracting N from that the reading point.

Memory 1001C stores characteristic table 4. Characteristic table 4 holds phase-characteristic value P[f] for each of control frequencies f[n]. Phase-characteristic value P[f] is obtained by converting, into the number of points shifted along the N points in sine-wave table 3a, a phase characteristic representing a change of a phase of sound output from loudspeaker 10 and reaches microphone 11.

Reference signal generator 14 generates corrected sine-wave signal r1[n] and corrected cosine-wave signal r2[n]. Based on control frequency f[n], reference signal generator 14 reads, from characteristic table 4, phase characteristic value P[f] corresponding to the control frequency Ant and generates corrected sine-wave signal r1[n] and corrected cosine-wave signal r2[n] based on phase characteristic value P[f].

One-tap digital filter 7 which is an adaptive notch filter stores filter coefficient W1[n], and outputs control signal y1[n] according to reference sine-wave signal x1[n] and filter coefficient W1[n]. Similarly, one-tap digital filter 8 which is an adaptive notch filter stores filter coefficient W2[n], and outputs control signal y2[n] according to reference cosine-wave signal x2[n] and filter coefficient W2[n].

Power amplifier 9 amplifies a signal input thereto, and outputs the amplified signal to loudspeaker 10. Adder 31 sums control signals y1[n] and y2[n] to produce noise control signal z[n], as shown in FIG. 1. Power amplifier 9 digital-to-analog convert the noise control signal z[n] into an analog signal, amplifies the analog signal, and outputs the amplified signal to loudspeaker 10.

Loudspeaker 10 produces an interference signal according to the signal output from power amplifier 9, and outputs the interference signal as a noise canceling sound. Adder 31, power amplifier 9, and loudspeaker 10 constitute interference signal generator 32 for outputting the sound to the outside to cancel the noise to be controlled.

Microphone 11 constitutes error signal detector 33 for detecting a sound produced due to interference between the noise canceling sound and the noise generated due to vibration of engine 1001B which needs to be controlled, and outputting the produced sound as error signal E[n]. The error signal E[n] detected by microphone 11 is output to coefficient updating units 12 and 13.

Coefficient updating unit 12 updates filter coefficient W1[n] of one-tap digital filter 7 timely by performing adaptive control algorithm based on corrected sine-wave signal r1[n] and error signal E[n]. Coefficient updating unit 13 updates filter coefficient W2[n] of one-tap digital filter 8 from time to time by performing the adaptive control algorithm based on corrected cosine-wave signal r2[n] and error signal E[n].

Control frequency corrector 15 updates correction value fcomp[n] based on filter coefficients W1[n] and W2[n].

An operation of active noise control apparatus 1001 according to the embodiment will be described in detail below. All operations including calculation of control frequency f[n], generation of noise control signal z[n], detection of error signal E[n], updating of filter coefficients W1[n] and W2[n] and determination of correction value fcomp[n] are carried out at the same cyclic period T (seconds). Control frequency f[n], noise control signal z[n], error signal E[n], filter coefficients W1[n] and W2[n] and correction value fcomp[n] represent values after the n-th period.

First, control frequency detector 2 measures a period of engine pulses P by causing interruption at every rising edge of engine pulses P, for instance, and checking a time between the rising edges. Control frequency detector 2 then calculates estimated control frequency fep[n] based on the measured period. Next, control frequency detector 2 calculates control frequency f[n] based on estimated control frequency fep[n] and correction value fcomp[n] in accordance with formula (1).

f[n]=fep[n]+fcomp[n] (1)

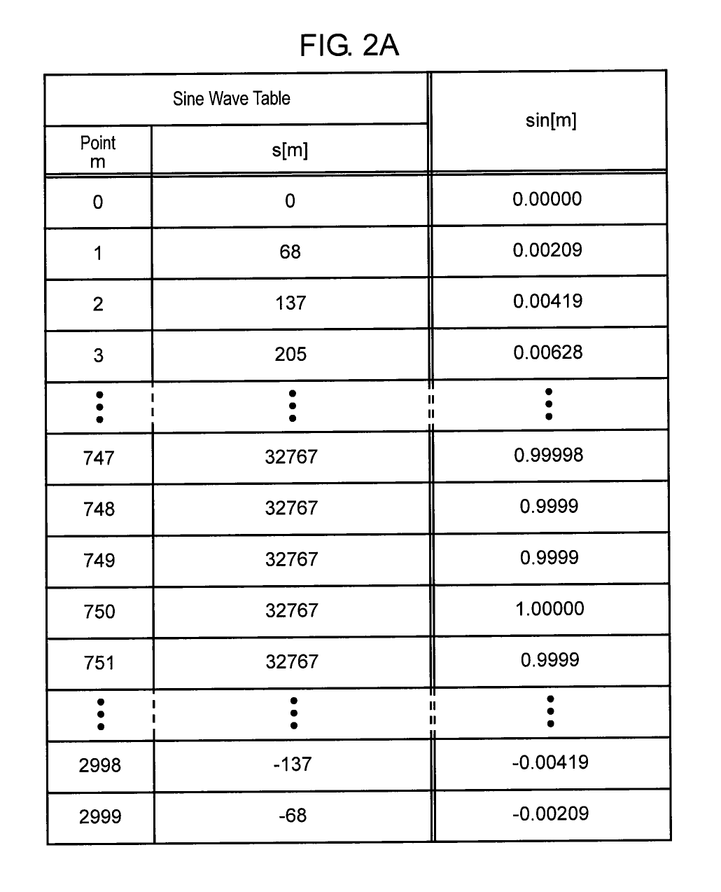

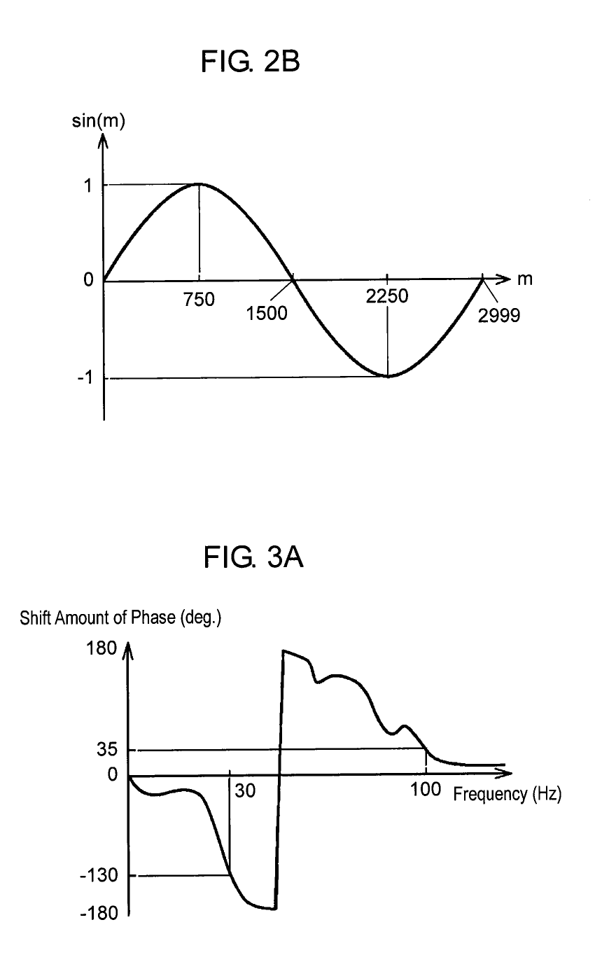

FIG. 2A shows sine-wave table 3 stored in memory 1001C. Sine-wave table 3 holds sampled values obtained by taking values of the sine wave at N points corresponding to equally divided N sections of one complete sin-wave cycle, and discretizing these values of the sine wave with a predetermined number of bits. Any of sampled values s[m] (where 0≦m<N) obtained by discretizing the values from the 0-th point up to the (N−1)-th point of the sine-wave with the number B of bits is expressed by the formula (2).

s[m]=int{(2B−1)×sin(360×m/N)} (2)

Here, int(x) denotes an integer part of real number x, and the unit of an angle of the sine wave function is degrees. In the case that N=3000 and B=16, for example, a table and a graph of sampled values s[m] are shown in FIGS. 2A and 2B, respectively. Sine-wave table 3 holds N sampled values s[m], or sampled values s[m] corresponding to the m-th points (0≦m<N).

Characteristic table 4 holds transmission characteristics of sound output from loudspeaker 10 to microphone 11, that is, holds amplitude characteristic values G[f] which are changing rates of amplitude at frequencies f[n] and phase characteristic values P[f] indicating phase-shift amounts at frequencies f[n], where f=f[n]. Phase characteristic values P[f] are values obtained by converting phase-shift amounts into a number of points out of the N points of sine-wave table 3. The phase-shift amount is zero (0) when the phase characteristic value P[f] is zero (0). When the phase-shift amount is phase[f] (degrees) at the frequency f[n] of f (Hz), the phase characteristic value PM is expressed by formula (3).

P[f]=int(N×phase[f]/360) (3)

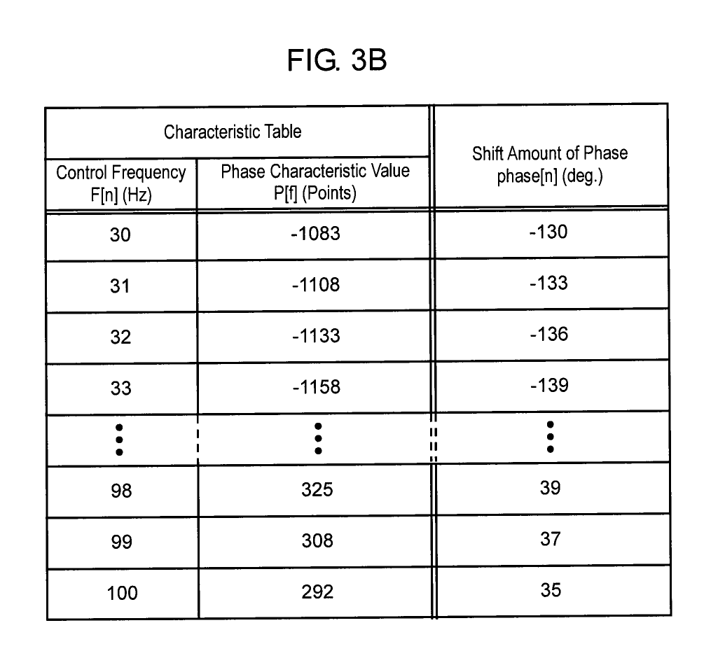

FIG. 3A shows phase-shift amount phase[f] with respect to frequency f[n] ranging from 30 Hz to 100 Hz when N=3000. FIG. 3B shows characteristic table 4 holding phase characteristic values P[f] corresponding to phase-shift amount phase[n].

Sine-wave generator 5 stores point i[n−1] read previously among N points m (0≦m<N) in sine-wave table 3, and shifts point i[n] read currently at intervals of one period T by calculating point i[n] based on control frequency f[n] using the formula (4).

i[n]=i[n−1]+(N×f[n]×T) (4)

If the value of point i[n] obtained by the formula (4) becomes equal to or larger than N, the point i[n] is replaced with a value given by subtracting N from that value. That is, the point i[n] to be read is expressed generally by the formula (4A).

i[n]={i[n−1]+(N×f[n]×T)} mod N (4A)

Here, “X mod Y” indicates the remainder obtained by dividing an integer X by an integer Y. In other words, the point i[n] satisfies 0≦i[n]<N.

At this moment, sine-wave generator 5 generates reference sine-wave signal x1[n] of the same frequency as control frequency f[n] by using the formulae (5) and (6) and sampled value s[m] retained in sine-wave table 4.

ix1=i[n] (5)

x1[n]=s[ix1] (6)

Cosine-wave generator 6 generates reference cosine-wave signal x2[n] of the same frequency as control frequency f[n] with a phase advancing reference sine-wave signal x1[n] by ¼ cycle by using the formulae (7) and (8).

ix2=i[n]+N/4 (7)

x2[n]=s[ix2] (8)

If the value of point ix2 obtained by the formula (7) becomes equal to or larger than N, the point ix2 is replaced with a value given by subtracting N from that value. That is, the point ix2 to be read is expressed generally by the formula (7A).

ix2=(i[n]+N/4) mod N (7A)

Point ix2 satisfies 0≦ix2<N.

Reference signal generator 14 extracts, from characteristic table 4, phase characteristic value P[f] corresponding to the control frequency f[n], and generates corrected sine-wave signal r1[n] and corrected cosine-wave signal r2[n] based on the formulae (9) to (12).

ix3=i[n]+P[f] (9)

r1[n]=s[ix3] (10)

ix4=i[n]+N/4+P[f] (11)

r2[n]=s[ix4] (12)

If the value of point ix3 obtained by the formula (9) becomes equal to or larger than N, the point ix3 is replaced with a value given by subtracting N from that value. That is, the point ix3 to be read is expressed generally by the formula (9A).

ix3=(i[n]+P[f]) mod N (9A)

The point ix3 satisfies 0≦ix3<N.

If the value of point ix4 obtained by the formula (11) becomes equal to or larger than N, the point ix4 is replaced with a value given by subtracting N from that value. That is, the point ix4 to be read is expressed generally by the formula (11A).

ix4=(i[n]+N/4+P[f]) mod N (11A)

The point ix4 satisfies 0≦ix4<N.

One-tap digital filter 7 outputs control signal y1[n] according to reference sine-wave signal x1[n] output from sine-wave generator 5 and filter coefficient W1[n]. One-tap digital filter 8 outputs control signal y2[n] according to reference cosine-wave signal x2[n] output from cosine-wave generator 6 and filter coefficient W2[n].

y1[n]=W1[n]×x1[n]

y2[n]=W2[n]×2[n]

Control signals y1[n] and y2[n] output from one-tap digital filters 7 and 8 are summed up to provide noise control signal z[n] which is input to power amplifier 9.

z[n]=y1[n]+y2[n]

Power amplifier 9 digital-to-analog converts noise control signal z[n] into an analog signal, amplifies the analog signal, and outputs the amplified signal to the outside as noise canceling sound S1 from loudspeaker 10. The noise canceling sound S1 interferes with control target noise S2 to cancel control target noise S2 to reduce the noise.

However, in the case that noise canceling sound S1 does not cancel control target noise S2 completely, noise canceling sound S1 interfering with control target noise S2 may produce another interference noise. Microphone 11 picks up and detects this interference noise as error signal E[n].

Error signal E[n] detected by microphone 11 is input to coefficient updating unit 12. Coefficient updating unit 12 updates filter coefficient W1[n] of one-tap digital filter 7 based on error signal E[n] and corrected sine-wave signal r1[n] by using convergence factor p of adaptive control and the formula (13). Similarly, coefficient updating unit 13 updates filter coefficient W2[n] of one-tap digital filter 8 based on error signal E[n] and corrected cosine-wave signal r2[n] by using convergence factor μ of the adaptive control and the formula (14).

W1[n]=W1[n−1]−μ×r1[n]×E[n] (13)

W2[n]=W2[n−1]−μ×r2[n]×E[n] (14)

An operation of control frequency corrector 15 will be described below.

First, control frequency corrector 15 defines complex number Zr[n] having filter coefficients W1[n] and W2[n] as the real part and the imaginary part, respectively, that are to be updated timely according to the formulae (13) and (14).

Zr[n]=W1[n]+j×W2[n]

Absolute value R[n] and argument θ1[n] of the complex number Zr[n] are expressed as the formulae (15), (16) and (16A).

(R[n])²=(W1[n])²+(W2[n])² (15)

tan(θ1[n])=W2[n]/W1[n] (16)

θ1[n]=tan⁻¹(W2[n]/W1[n]) (16A)

Complex number Zr[n] is a component of the noise control signal z[n] excluding a component changing according to frequency f[n].

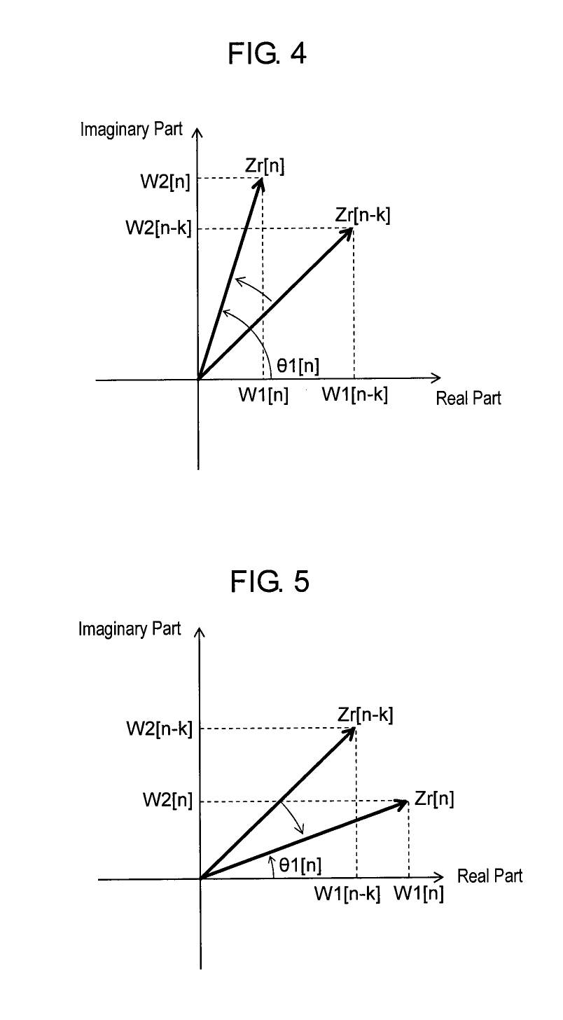

FIGS. 4 and 5 illustrate complex number Zr[n] plotted on a complex plane. Control frequency corrector 15 calculates correction value fcomp[n] based on a change of argument θ1[n] of complex number Zr[n] at every sampling period T. When argument θ1[n] of complex number Zr[n] changes in a positive direction from argument θ1[n-k] of the previous complex number Zr[n−k], as shown in FIG. 4, the correction value fcomp[n] is increased to raise control frequency f[n]. On the other hand, when argument θ1[n] changes in a negative direction, as shown in FIG. 5, the correction value fcomp[n] is deceased to lower the control frequency f[n]. An optimum correction value fcomp[n] is determined according to the amount of the change of argument θ1[n].

Control frequency detector 2, sine-wave generator 5, one-tap digital filters 7 and 8, coefficient updating units 12 and 13, reference signal generator 14 and control frequency corrector 15 constitute control signal generator 1002 generating control signals y1[n] and y2[n]. Adder 31 of interference signal generator 32 sums up control signals y1[n] and y2[n] to generate noise control signal z[n]. Power amplifier 9 digital-to-analog converts the noise control signal z[n] into an analog signal, amplifies the analog signal, and outputs the amplified signal to loudspeaker 10. Loudspeaker 10 produces an interference signal using the signal output from power amplifier 9, and outputs the interference signal to the outside as a noise canceling sound. Microphone 11 detects a sound produced by interference between the noise canceling sound and a noise generated due to vibration of engine 1001B which needs to be controlled, and outputs the detected sound as error signal E[n] to coefficient updating units 12 and 13.

A principle of the above method of causing control frequency f[n] to approach the frequency of the noise actually being generated will be described with using continuous time “t”,

Here, control frequency f[n] is frequency Fctrl, the noise control signal z(t) can be given by absolute value R(t), argument θ1(t) (rad), and the formula (17).

z(t)=R(t)×sin(2π×Fctrl×t+θ1(t)) (17)

If the noise, i.e., control target noise S2, has frequency Fnoise, an adaptive notch filter adjusts argument θ1(t) to cause the frequency of noise control signal z(t) to be equal to that of the noise (with an opposite phase), which leads to the following formulae.

Fctrl+(θ1(t)/2π×t)=Fnoise

θ1(t)/t=2π×(Fnoise−Fctrl) (18)

The left side of the formula (18) is the rate of the change of argument θ1(t).

Argument θ1(t), upon increasing, provides the relation, Fnoise>Fctrl. Argument θ1(t), upon decreasing, provides the relation, Fnoise<Fctrl. Therefore, correction value fcomp[n] adjusted by the above method can cancel control target noise S2 with noise canceling sound S1 generated from noise control signal z[n], thus reducing control target noise S2.

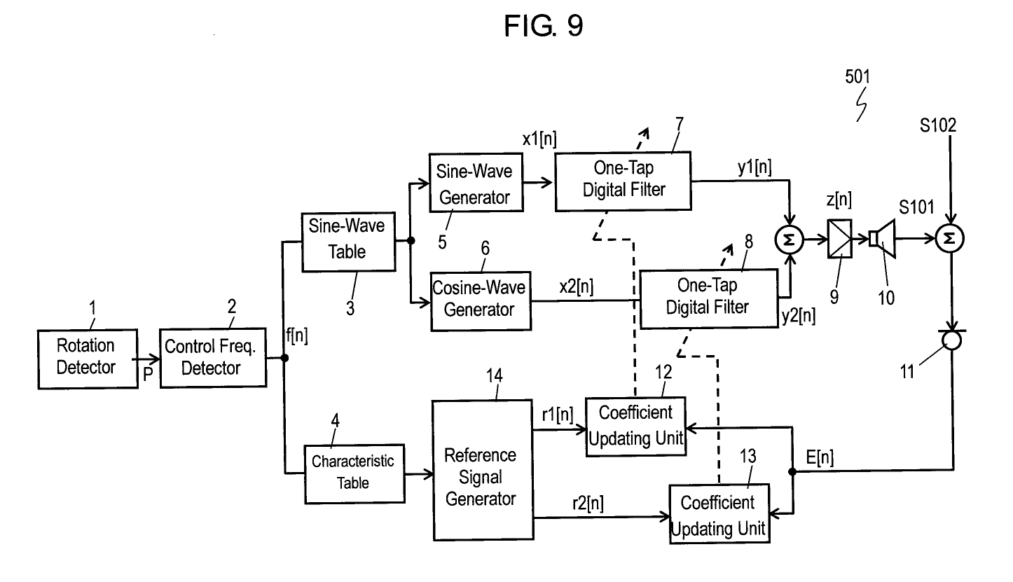

Active noise control apparatus 1001 according to this embodiment will be explained below with respect to conventional active noise control apparatus 501 shown in FIG. 9.

Control frequency f[n] may shift from a frequency of the noise actually being generated in conjunction with the frequency of engine pulses P due to a failure of engine rotation detector 1. In this case, conventional active noise control apparatus 501 cannot reduce the noise sufficiently. In active noise control apparatus 1001 according to this embodiment, on the other hand, control frequency corrector 15 increases and decreases correction value fcomp[n] to cause control frequency f[n] calculated based on engine pulses P to approach the frequency of the noise actually being generated, thereby reducing the noise sufficiently.

Instead of argument θ1[n] of complex number Zr[n] having filter coefficient W1[n] as the real part and filter coefficient W2[n] as the imaginary part, correction value fcomp[n] can be adjusted based on a change of argument θ2[n] of complex number Zs[n] given by the formula (19) having filter coefficient W2[n] as the real part and filter coefficient W1[n] as the imaginary part.

Zs[n]=W2[n]+j×W1[n] (19)

The argument θ2[n] of complex number Zs[n] is expressed as formulae (20) and (20A):

tan(θ2[n])=W1[n]/W2[n] (20)

θ2[n]=tan⁻¹(W1[n]/W2[n]) (20A)

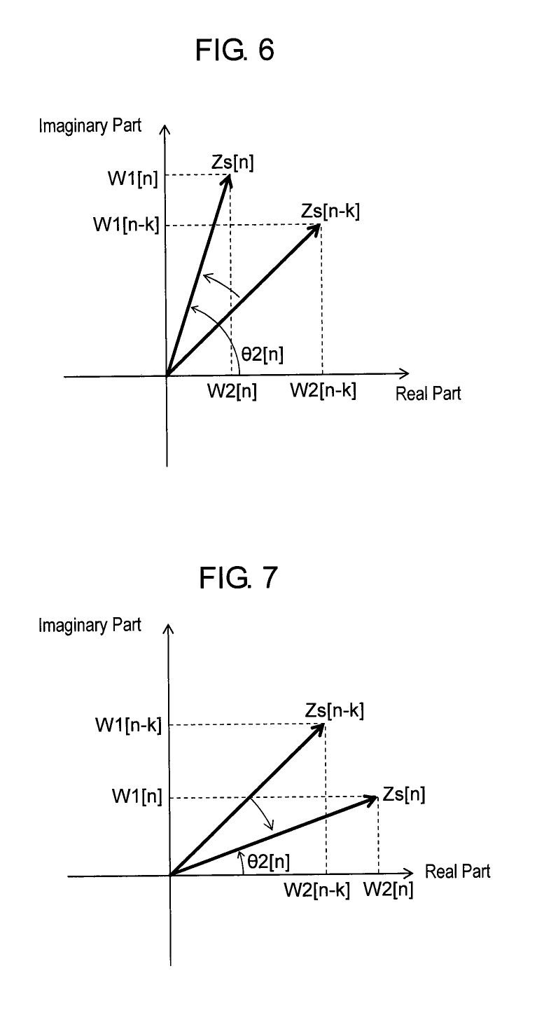

FIGS. 6 and 7 show complex number Zs[n] plotted on a complex plane. Since the right side of the formula (20) is the reciprocal of the right side of the formula (16), when argument θ2[n] changes in a positive direction, the correction value fcomp[n] of the control frequency is descreased to lower the control frequency f[n]. When argument θ2[n] changes in a negative direction, the correction value fcomp[n] is increased to raise the control frequency f[n], thereby providing the same effects.

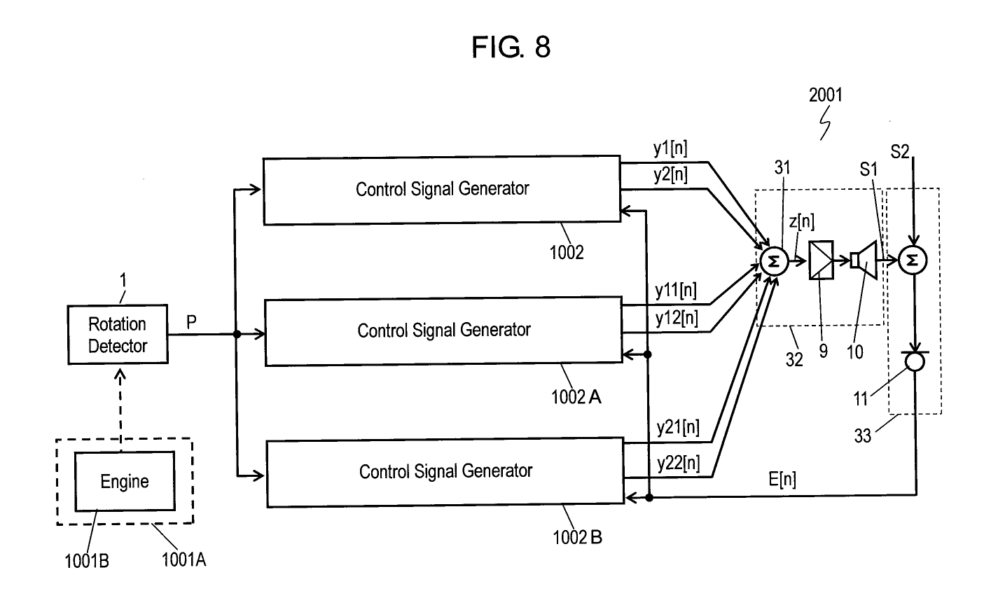

FIG. 8 is a block diagram of another active noise control apparatus 2001 according to the embodiment. In FIG. 8, components identical to those of active noise control apparatus 1001 shown in FIG. 1 will be denoted by the same reference numerals. Active noise control apparatus 2001 shown in FIG. 8 further includes control signal generators 1002A and 1002B each having a structure similar to control signal generator 1002. Each of control signal generators 1002A and 1002B includes control frequency detector 2, sine-wave generator 5, one-tap digital filters 7 and 8, coefficient updating units 12 and 13, reference signal generators 14, and control frequency corrector 15, similarly to control signal generator 1002 shown in FIG. 1. Control signal generator 1002A generates control signals y11[n] and y12[n] similarly to control signal generator 1002. Control signal generator 1002B generates control signals y21[n] and y22[n] similarly to control signal generator 1002. Control frequencies of control signal generators 1002, 1002A and 1002B are different from each other. In other words, the frequency of control signals y1[n] and y2[n], the frequency of control signals y11[n] and y12[n], and the frequency of control signals y21[n] and y22[n] are different from each other. Adder 31 sums up all the control signals y1[n], y2[n], y11[n], y12[n], y21[n] and y22[n], and produces noise control signal z[n]. Power amplifier 9 digital-to-analog converts the noise control signal z[n] into an analog signal, amplifies the analog signal, and outputs the amplified signal to loudspeaker 10. Loudspeaker 10 produces an interference signal using the signal output from power amplifier 9, and outputs the interference signal to the outside as a noise canceling sound. Microphone 11 detects a sound produced as a result of interference between the noise canceling sound and the noise generated due to vibration of engine 1001B which needs to be controlled, and outputs error signal E[n] to coefficient updating units 12 and 13 of each of control signal generators 1002, 1002A and 1002B. Active noise control apparatus 2001 can hence reduce the noise having plural frequencies.

### INDUSTRIAL APPLICABILITY

An active noise control apparatus according to the present invention can effectively reduce noise even if a control frequency shifts from a frequency of the noise actually being generated, and it is therefore useful for a device for reducing the noise, for example, inside a vehicle compartment.

### REFERENCE NUMERALS IN THE DRAWINGS

2 Control Frequency Detector

5 Sine-Wave Generator

6 Cosine-Wave Generator

7 One-Tap Digital Filter (First One-Tap Digital Filter)

8 One-Tap Digital Filter (Second One-Tap Digital Filter)

12 Coefficient Updating Unit (First Coefficient Updating Unit)

13 Coefficient Updating Unit (Second Coefficient Updating Unit)

15 Control Frequency Corrector

32 Interference Signal Generator

33 Error Signal Detector

1001 Active Noise Control Apparatus

1. An active noise control apparatus comprising:
a control frequency detector for determining a control frequency which is a frequency of a noise to be controlled;
a sine-wave generator for generating a reference sine-wave signal having the determined control frequency;
a cosine-wave generator for generating a reference cosine-wave signal having the determined control frequency;
a first one-tap digital filter for outputting a first control signal obtained by multiplying the reference sine-wave signal by a first filter coefficient;
a second one-tap digital filter for outputting a second control signal obtained by multiplying the reference cosine-wave signal by a second filter coefficient;
an interference signal generator for generating an interference signal based on a noise control signal obtained by summing the first control signal and the second control signal;
an error signal detector for detecting an error signal produced due to an interference between the interference signal and the noise;
a first coefficient updating unit for updating the first filter coefficient according to the error signal;
a second coefficient updating unit for updating the second filter coefficient according to the error signal; and
a control frequency corrector for correcting the control frequency according to the first filter coefficient and the second filter coefficient.

2. The active noise control apparatus according to claim 1, wherein the control frequency corrector corrects the control frequency according to a change of an argument of a complex number having the first filter coefficient and the second filter coefficient as a real part and an imaginary part, respectively.

3. The active noise control apparatus according to claim 2, wherein the control frequency corrector raises the control frequency when the argument changes in a positive direction, and lowers the control frequency when the argument changes in a negative direction.

4. The active noise control apparatus according to claim 1, wherein the control frequency corrector corrects the control frequency according to a change of an argument of a complex number having the first filter coefficient and the second filter coefficient as an imaginary part and a real part, respectively.

5. The active noise control apparatus according to claim 4, wherein the control frequency corrector lowers the control frequency when the argument changes in a positive direction, and raises the control frequency when the argument changes in a negative direction.

6. The active noise control apparatus according to claim 1, wherein the reference cosine-wave signal has a phase advancing a phase of the reference sine-wave signal by 90 degrees.
